(19) United States
(12) Patent Application Publication
(10) Pub. No.: US 2017/0357697 A1
(43) Pub. Date: Dec. 14, 2017

(54) USING ADAPTORS TO MANAGE DATA INDEXED BY DISSIMILAR IDENTIFIERS

(71) Applicant: LinkedIn Corporation, Mountain View, CA (US)

(72) Inventors: Bita Gorjiara, Sunnyvale, CA (US); Gururaj Seetharama, San Jose, CA (US)

(21) Appl. No.: 15/177,133

(22) Filed: Jun. 8, 2016

(51) Int. Cl. G06F 17/30

(52) U.S. Cl. CPC G06F 17/30554; G06F 17/30569; G06F 17/30312

(57) ABSTRACT

Techniques and a system are provided for a profile manager system that stores multiple profiles. These profiles are used by a content selection system to match entities to content for which the entities would be best suitable. The profile manager system uses adaptors to access and query information stored in each data store. The adaptors include a configuration file, specific for each data store.

### TECHNICAL FIELD

The present disclosure relates to data processing using databases and, more specifically, to reducing time, memory, and other computing resources when data processing using multiple identifiers. SUGGESTED GROUP ART UNIT: 2161; SUGGESTED CLASSIFICATION: 707.

### BACKGROUND

Computers allow humans access to information in large quantities, with greater ease than before. Even for data sources that were “siloed” or kept separate, computers help to break down walls separating these data sources. These different data sources may be created, maintained, or modified by different companies or organizations, but sometimes different data sources exist even within a single company or organization.

The ease of producing vast amounts of data from various data sources outstrips our ability to make sense of and use the data. Data from each data source is usually stored in different forms, meaning that the information from each source may be encoded using different formats, have different digital identifiers for the same or similar pieces of information, or include other differences. This makes it difficult to understand how information from one data source relates to another piece of information from another data source.

As one example, it is useful to be able to properly select content for a person so that it matches their taste. However, each person's digital life has gotten much more complicated. A person may have information spread across multiple data sources, for example, browsing history stored with one service, purchase history with another, social networking profile including their friends and family, news services they visit, and communications platforms they use to reach out to others. Each of these data sources is an important, but incomplete picture of the person. For example, a social networking site may indicate who a person knows and communicates with, but will generally lack information on what the person's viewing history is. As another example, a news service may indicate news preferences of a user, but will not have information with whom the user shares news articles with.

It is often computationally expensive to merge all these data sources together. For example, the processing power to scour data from each data source and then to reconcile data from the data sources is difficult and time-consuming. To reduce these computationally expensive operations, merging is avoided or done infrequently, resulting in information that is stale and of reduced usefulness.

Therefore, there is a need to reach a balance between computationally expensive operations and having up-to-date information.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 illustrates a content selection system, according to an embodiment.

FIG. 2 shows an example flow of how a request is processed by various components of the content selection system.

FIG. 3 is a flowchart that depicts an example process for using adaptors to generate profiles.

FIG. 4 is a flowchart that depicts an example process for using adaptors to perform profile effectiveness experiments.

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

A content selection system is described herein which implements techniques for determining, from various pieces of available content, whether to transmit content to a user and select what content to transmit to the user. As an example, multiple data sources may hold information on the user relevant to what content should be selected. In order to properly generate a profile for the user, data is retrieved from the data sources using multiple adaptors. An adaptor converts requests for user information into a query that may be executed by each specific data source.

The content selection system may be used with various types of content. As an example, content items may include different types (e.g., application, audio, image, message, model, multipart, text, video, or any combination of these) and for different purposes (e.g., entertainment, advertisement, education, or other purposes).

The content selection system may use other systems, such as a profile manager system or a cache manager system. In various embodiments, the content selection system may include both the profile manager system and the cache manager system, or the profile manager system, depending on the specific needs of the content selection system.

The profile manager system includes features to create profiles of entities. These profiles are used by the content selection system to match entities to content for which the entities would be best suitable. The profile manager system allows the content selection system to identify different pieces of data from different data sources and match the different pieces of data when the pieces of data refer to the same entity. The profile manager system may also provide merging of the different pieces of data, when they are matched as referring to the same entity. The profile manager system does the merging “lazily,” meaning that the merging is done on-demand according to a specified event. For example, the profile manager system may execute a merge when a request for content or other specified event occurs.

In an embodiment, a request occurs when a user requests information from a remote computing device. The requests may come from the user's computing device via various means. For example, the user may be using an application, a web browser, a background application, or any other method to request information remotely. In an embodiment, a request comes from a Web browser for a Web page. The Web page includes a portion on the Web page where content is required. For a single Web page, there may be multiple portions requiring content and, for each portion requiring content, a separate request is made. For example, a Web page may include more than one advertisement and for each advertisement, a separate request is made.

When performing a merge, the profile manager system identifies a dominant identifier corresponding to an entity that made a request, such as a user entity that has requested a Web page. The dominant identifier may be any identifier that maps to other identifiers used by the data sources, including an identifier that is already used by a data source. For example, a social networking identifier may be used as both the dominant identifier as well as the identifier for the data source from the social network. In an embodiment, the dominant identifier is selected to be a long-lasting identifier. The long-lasting identifier is an identifier that is unlikely to expire or change. Some examples of long lasting identifiers include account log on information, email addresses, and others. Some examples of non-long lasting identifiers included in the content selection system 100 include IP addresses, mobile device identifiers, and others.

When the dominant identifier is identified, the profile manager system performs a lookup to determine what additional identifiers correspond to the dominant identifier. These additional identifiers correspond to identifiers used by one or more data sources to identify the same entity represented by the dominant identifier. The profile manager system then combines information from the data sources to create a profile for the entity.

In various embodiments, the profile manager system may execute merges when various criteria are met. For example, merging may be done when a retargeting event has been received. As discussed in greater detail elsewhere, a retargeting event may be when the profile manager system receives an opt-out request, a language change request, or many other types of events. Merging may also be done when a certain time period has elapsed. For example, the profile manager system may include a time period, where the time period specifies a length of time before previously created profiles becomes stale. When the time period has elapsed, the profile manager system may execute a merge to generate updated profile information.

The cache manager system includes features allowing the content selection system to determine when to use information stored in a cache memory or when to request a refresh of profile information by executing a merge of information from two or more data sources. Response time is often a limiting factor when responding to a request. Some examples of where there is a low latency requirement includes advertising on real-time bidding advertisement exchanges. On these exchanges, an advertisement request should be completed in less than 100 milliseconds, hence, the expected time budget for the profile manager may be as low as 5 milliseconds. If a response to the request occurs after this time, then the request may no longer be usable.

When profile information is requested for an entity, the cache manager system performs a cache lookup, to determine whether there is profile information for the entity and, if there is profile information, whether the profile information may be used. As an example, even if there exists profile information on an entity, the cache manager system may determine to use or not use the profile information if the profile information is stale (e.g., time when the profile information was generated has exceeded a predetermined amount of time, signifying that the information is likely inaccurate or of low value).

If the profile information is not to be used, then the profile manager determines how to respond to the request. The cache manager system may attempt to generate the profile information in response to the request (e.g., using the profile manager system). However, if the time required to generate the profile information exceeds a certain amount of time, the profile manager returns whatever incomplete data that could be fetched for the given time, and then asynchronously fetches the full/complete profile to be used for subsequent requests.

### Sample Use Case: Advertising Content Selection

In an embodiment, the content selection system 100 is used to select advertisements. Advertisement targeting data comes from various data sources. Some of it comes from data sources managed by the same organization executing the content selection system 100. For example, if the organization is a social networking Website, such as LINKEDIN, then there are different data stores available to use to select the best advertisement for users. An example are data stores used for member profiles (including information such as skills, companies, etc.). Some information may come from data stores of partners, some may come from data stores with purchased information, or some information derived information from any of these data stores (e.g., through the use of data analytics). Each of these data stores uses an identifier to identify a user. However, the identifiers used for the same user may be different across the data stores. Hence, bits and pieces of targeting data is collected using different identifiers (such as LINKEDIN member identifier, mobile device identifier, browser identifier, email addresses, phone numbers, hashed email address, and other identifiers). To create a complete profile to target content for a user, the information collected from different identifiers should be merged together. Some examples that may trigger a merge are:

(1) Data associated with one of identifiers is updated.

(2) Relationship between identifiers change. New identifiers may be discovered for a user (they login via a new device for instance), or existing IDs may expire or be deleted.

Given the large number of users and potential requests for content from users there are two approaches that may be used:

(1) Offline data merge, where mapping identifiers and merging is limited to certain times. Offline data merge is slow to run. Hence, the profiles generated during the offline data merge can be generated a few times a day, which would not be fresh enough for retargeting scenarios. Another limitation of offline merge is handling of multi-version derived data, in which merged data should be created for all permutations of all versions. As a result, storage of the merged data would not be scalable. In the derived data scenario, this may mean that a first algorithm used to generate derived data from machine learning techniques generates a first version of information and a second algorithm generates a second version of information, even though the first and second algorithms are based off the same data sets. Alternatively, a single algorithm may generate different versions of derived data, by changing assumptions used to generate the derived data. For example, suppose the algorithm calculates values to determine whether various thresholds are met using a mix of information from one or more data sources as well as constant values. By adjusting the constant values, additional versions of derived data may be produced, even though the same algorithm and data sources are used.

Different versions of data may result in a rapid increase in data storage needed to generate, compare, and use the data. For instance, assume there are seven total data stores, five data stores that provide data in a single version, one data store that has two versions of its data, and another data store that has three versions of its data. The total number of possible profiles generated using all of the data stores would then be six (2 times 3). To properly test an algorithm using AB testing, all these profiles would need to be created and stored. This means that it is possible to quickly run out of memory in one or more computing devices used to store the information, just by generating the profiles. As a result, more computing devices would be needed to store the merged data, which would increase the cost of finding and matching content items, and the system could not scale as the number of data sources and versions of information created from the data sources increase.

(2) Stream processing, where a stream of events is received by a near real-time system and, in response, the merged targeting data is generated. These events do not necessarily correspond to requests made by users and may be any piece of information newly received by the system. The downside of this approach is the rate of events is high and triggers many merges that may not even be used. This would be waste of processing power and increase the cost of serving such data. Additionally, similar to offline-merge approach, this approach also has limitations in handling the multi-version stores, and may require producing merged data for all combinations of data versions.

To serve relevant content to users, many data sources with different user information are collected, inferred, or even purchased. For instance, LINKEDIN's advertising serving system may use profile data, various segment info (internal or advertiser-defined), fuzzy searches (including such things as synonyms, singular/plural forms, possible misspellings, stemmings, related searches, and other relevant variations), and derived data to show relevant content. In general, different advertising targeting data may be keyed by different user identifiers (e.g., login identifier, mobile ID, browser ID, email addresses, phone numbers, or partner IDs), and the relationship between IDs may evolve (e.g., ownership of a phone number may change, users may opt-out of a partners' network, a user changes her mobile device, etc.).

The profile manager system 102 learns what identifiers are used for a user across the different data stores. The raw data in these data stores are keyed by their original identifier in each respective data store and a merge is executed lazily based on users' content item requests. When an ad request comes, the profile manager system 102 looks up identifiers related to a user associated with the ad request and fetches targeting data associated with the user from different stores. Merged targeting data may be cached for subsequent access.

In an embodiment, the cache does not include targeting information for all of the users represented in the data stores. The content selection system 100 limits the size of the cache, but keeping only a certain number of targeting information or keeping only targeting information for a certain period of time before it is removed. This allows the content selection system 100 to reduce the necessary size of the cache.

### Example Content Selection System

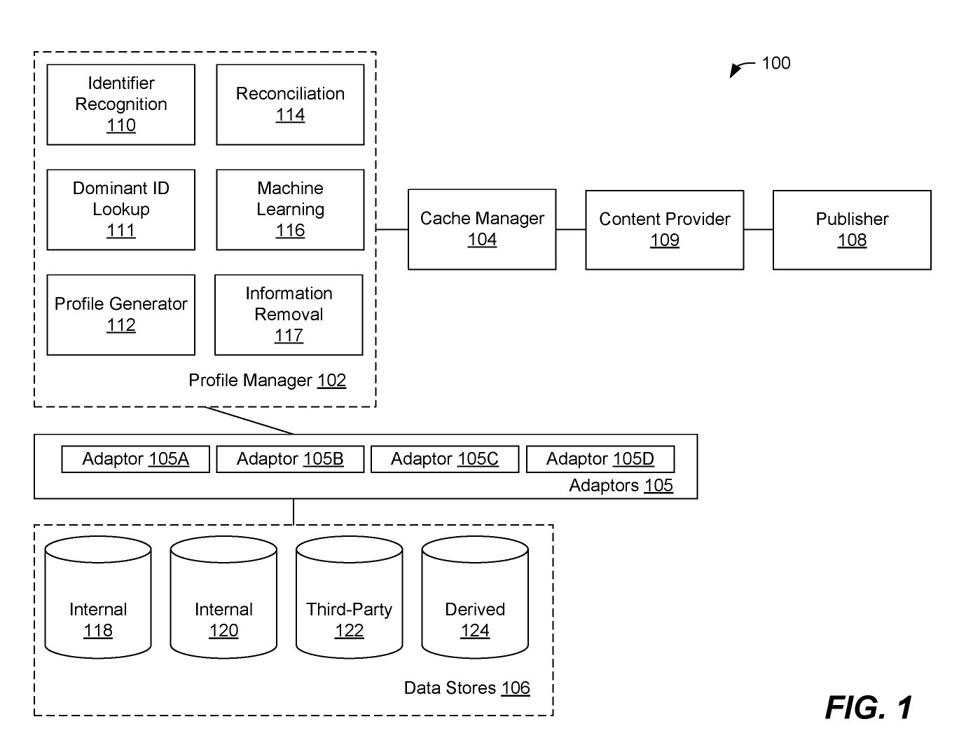

FIG. 1 illustrates a content selection system 100 in which the techniques described may be practiced according to certain embodiments. The content selection system 100 is a computer-based system. The various components of the content selection system 100 are implemented at least partially by hardware at one or more computing devices, such as one or more hardware processors executing instructions stored in one or more memories for performing various functions described herein. For example, descriptions of various components (or modules) as described in this application may be interpreted by one of skill in the art as providing pseudocode, an informal high-level description of one or more computer structures. The descriptions of the components may be converted into software code, including code executable by an electronic processor. The content selection system 100 illustrates only one of many possible arrangements of components configured to perform the functionality described herein. Other arrangements may include fewer or different components, and the division of work between the components may vary depending on the arrangement.

The content selection system 100 includes various components used to select content. For ease of understanding, these components are broken into different groups: a profile manager system 102, a cache manager component 104, multiple adaptor components 105, a data stores (or data sources) component 106, a publisher component 108, and a content provider component 109. Each component group may have one or more additional components as part of the group. However, alternate embodiments of the content selection system 100 may include more or fewer components in each component group, as well as component groupings different than the one shown in FIG. 1.

Although the content selection system 100 shows both the profile manager system 102 and the cache manager component 104, various embodiments of the content selection system 100 may include only the profile manager system 102.

The profile manager system 102 is responsible for creating, updating, and managing profiles for entities stored in the system. In an embodiment, the profile manager system 102 is used with data on persons, such as Internet users. However, various embodiments may include other types of entities such as groups, organizations, or other types. An identification recognition component 110 is responsible for determining, based on a particular piece of data from the data stores component 106, to which user the particular piece of data refers.

A dominant identifier lookup component 111 is responsible for determining, based on the user identified by the identification recognition component 110, a corresponding dominant identifier for the user. For example, the identification recognition component 110 has determined that a first piece of data corresponds to a first user because of a first identifier in the first piece of data. The dominant identifier lookup component 111 performs a lookup using the first identifier to determine what the corresponding dominant identifier is for the first identifier. The dominant identifier may be the same or different than the first identifier.

In an embodiment where profiles of the profile manager system 102 are Internet users, the identification recognition component 110 receives a first piece of information on the Internet user. For example, this may be Web browsing information of the Internet user on a social networking Website and the identification recognition component 110 determines a user account name is included with the Web browsing information. Using the user account name, the dominant identifier lookup component 111 translates this information to a dominant identifier used by the profile manager system 102.

A profile generator component 112 is responsible for merging pieces of information in the data stores component 106 to create a profile. For example, after the dominant identifier lookup component 111 has determined a dominant identifier for a piece of information, the profile generator component 112 may retrieve an existing profile associated with the dominant identifier. The existing profile may need to be updated with pieces of information, from one or more data stores. A reconciliation component 114 is responsible for working with the profile generator component 112 to determine how a piece of information is incorporated with an existing profile if there is a conflict between pieces of information from data stores and the existing profile. The reconciliation component 114 may replace, update, or supplement already existing information from the piece of information with the existing profile. For example, if an existing profile already indicates a user is interested in cars and the piece of information indicates the user is interested in travel, then the reconciliation component 114 may determine the updated profile may include both cars and travel as interests or replace cars with travel.

In an embodiment, the profile generator component 112 includes a consolidator engine. The consolidator engine is responsible for combining information from various data sources to produce a profile. For example, if a first user data is retrieved from a first data source and a second user data is retrieved from a second data source, the consolidator engine creates a single profile from the first and second user data. This may result in conflicting data being reconciled by the consolidator engine. The content selection system 100 includes multiple methods to resolve conflicts, as discussed in greater detail elsewhere in this application.

A machine learning component 116 is responsible for improving results determined by the content selection system 100. The content selection system 100 may employ various types of testing methods to determine the accuracy of the profiles created by the profile manager component 102. For example, the profile manager assumes that, if the profiles are highly accurate for users, then the likelihood of users approving, viewing, or interacting with content selected based on the profiles will increase. Different testing techniques may be used to determine and compare the increased likelihood. Some of these testing techniques include AB testing, click-through testing, successful conversion testing, and many other types of testing. The machine learning component 116 may work in conjunction with the content provider component 109.

An information removal component 117 is responsible for removing profiles or information from profiles, based on specific events. As discussed in greater detail elsewhere, there may be a variety of reasons why, for a profile that has already been generated and stored (e.g., in cache storage) may need to be updated.

The cache manager component 104 is responsible for retrieving profiles when a request received. As discussed in greater detail elsewhere, the content selection system 100 provides more than one method to supply a profile, depending on various factors.

The data stores component 106 includes various data sources accessible by the profile manager system 102 to generate profiles. Each data source is associated with a reliability or query time indicator. For example, different data sources may have different response times. Some data sources may have a very low response time (e.g., load on the data source is low, data source is hosted on fast computing equipment, data source is an internal data source, data source prioritizes requests from the profile manager, or other reasons) when compared to others. As discussed in greater detail elsewhere, this assists the cache manager component 104 to determine whether a request may be satisfied.

Some examples of data sources include:

Internal Data Sources 118 and 120.

These include data sources created, maintained, and managed by an organization that is executing the profile manager system 102. Each data source may come from different teams from within the organization, such as a team focusing on user submitted profile information and a team focusing on user submitted connections information.

Third-Party Data Source 122.

This includes data sources created, maintained, and managed by an organization different than an organization executing the profile manager system 102. As an example, the third-party data source 122 includes data stores accessible by one organization from another organization through a rental or sharing agreement between the organizations.

Derived Data Source 124.

This includes data sources created, maintained, and managed by an organization that were not provided by users themselves, but determined through analyzing pieces of information from other data stores (e.g., internal data stores, third-party data stores, or other data stores). For example, if a user is associated with pieces of information relating to automobiles, such as online activity indicating visiting Web pages discussing automobiles or visiting Web pages of car dealerships, then the derived data source may indicate an interest for the user in automobiles.

As discussed in greater detail following, in an embodiment data stored in data stores of the content selection system 100 may conform to a schema.

There are numerous ways the content selection system 100 may produce or receive produced information for the derived data store. Derived data is usually generated using multiple machine learning algorithms, and through experimentation, the best algorithm is selected. Such experimentation is called A/B testing. An example of A/B testing includes: The profile manager system 102 is responsible for handing A/B testing. For instance, suppose have we have a data provider that needs to experiment with two algorithms (algorithms 1 and 2), and has provided its data in a single store. At runtime, depending on A/B testing requirements, the profile manager may read data generated by algorithm 1 for a subset of users, and data generated by algorithm 2 for the rest of users. The results for profiles generated using the derived information may be compared, to determine whether algorithm 1 or algorithm 2 produced more positive outcomes. Some examples of positive outcomes may be increased conversion rate for content items matched using profiles, increased user interaction for content items matched using profiles, increased ease of use for content items matched using profiles, or many other outcome types.

Five examples of different data stores are shown in the data stores component 106, however there may be fewer or more data stores than shown here. For example, there may be more internal data sources than shown in FIG. 1 or no third-party data source 122. Other data stores may also be included, not shown in FIG. 1.

The adaptors component 105 is responsible for providing information from the data stores component 106 for the profile manager system 102. FIG. 1 shows four adaptors 105A, 105B, 105C, and 105D however the content selection system may have fewer or less, depending on the need of the content selection system. As an example, there may be one adapter for each data store of the data stores component 106 or, in the case of FIG. 1, four data stores. Each adapter of the adaptors component 105 may use the same configuration file, or two or more configuration files.

For example, for a first data source, a corresponding first configuration file specifies what attributes are stored in the first data source. These attributes may be referenced using the configuration file, which specifies a listing of attribute names for each attribute stored in the first data source. In an embodiment, a configuration file comprises: a name of an adapter associated with the configuration file, data store information to identify the data store associated with the adapter, a type of identifier supported (needed to optimize request count), an output attribute section name (determines how values retrieved from a data store are arranged or grouped, so that the profile manager system 102 understands what information corresponds to what attribute), experiment name (specifies whether the configuration file is used for experimentation and which experiment or treatment to use during the experiment (e.g., AB testing)).

The profile manager system 102 determines what properties are required to satisfy a request, and the adaptors component 105 determines a source-specific request to retrieve the properties from the data source. The adaptors component 105 may include one or more executing instances of adaptor code, for each data store used by the content selection system 100. A configuration file may be composed by a user or representative of content selection system 100 even though the corresponding data source may come from a third-party entity. A configuration file may specify a priority level of the corresponding data source (e.g., all data from the data source has priority over any conflicts with data from other data sources) or a data item or type of data item (e.g., geographic information from this data source has priority over geographic information from one or more other data sources).

The publisher component 108 is responsible for indicating when there are opportunities for the content selection system 100 to include content. For example, the publisher component 108 notifies the content selection system 100 that a user has viewed a Web page, and that there are one or more opportunities for the content selection system 100 to include content.

The content provider component 109 is responsible for content in the content selection system. The content provider component 109 uses profile information from the profile manager system 102 to match the user with the most relevant content item.

### Data Schema

In an embodiment, the profile manager system 102 includes various data sources, each storing data conforming to a common data schema. The schema assists in structuring the data sources into different logical sections that are independent of what data is stored. The schema also allows queries to execute against the data sources by ensuring that information stored in the data source is indexed and organized in an efficient and usable way. As discussed elsewhere, adaptors may be used to translate queries for the data sources. For example, a common request key may be used with the schema. The common request key is converted by the adaptor into a source-specific key. The source-specific key indexes, based on the data schema, where and how the information is stored in the data source.

The source-specific key is usable for the data source it was created for. For example, the data source specific-key may include details such as what attributes are needed to satisfy a request and the corresponding attribute names for the requested attributes. Thus, it is possible that a source-specific key will execute properly against one data source but not another data source. For example, a first data store may include attributes that a second data store may not have or may have a different name for.

A common request key may include various components. In an embodiment, a common request key includes a user identifier, provider identifier, and version information. Table 1 provides additional details on what this embodiment of the schema includes.

TABLE 1

| Field | Purpose |
|---|---|
| User | Requests for information include a user identifier. The user |
| Identifier | identifier may be mapped to a dominant identifier, which may |
| | be used by the profile manager 102 to identify or retrieve |
| | data from the data stores. The user identifier may be any of |
| | the types as discussed in this application, and even requests |
| | for non-members may include a user identifier (e.g., IP |
| | address, e-mail address, or other). |
| Provider | Specifies a data store providing data. This allows multi- |
| Identifier | tenancy for data stores. This means that a single data store |
| | can potentially host multiple data sets thus reusing the |
| | allocated store capacity efficiently. |
| Version | Version information of stored data. Sometimes a data source |
| | may store more than one version of its information to assist |
| | in data experimentation. |

Data stored using the schema include attributes. These attributes may include one or more associated values. Attribute names are standardized, so that for the same attribute, the attribute's name is uniform across different data sources. For example, for a zip code of a user, the attribute name may be “zipCode” for first and second data sources. A timestamp of the attribute may be included. For example, the timestamp may be used for conflict resolution, as discussed elsewhere. Each attribute value may have an optional score. The score specifies the confidence in the value, and timestamp indicates the time a particular attribute was modified. Table 2 below provides an example of information stored using the schema. However, a person of skill in the art would recognize that this includes just one example of how data may be stored using a schema and that other methods exist.

TABLE 2

Purpose
″ attributes″: [
{ “name”: ″graduateYear″,

″values″: [ { ″value″: ″2007″} ]

```
  },
  {“name”: ″zipCode″,
```

″values″: [{ ″value″: ″94043″} ]

```
  },
  {“name”: ″customSegment″,
  ″values″: [ { ″timestamp″: 1552555340888,
  ″value″: ″10451″}, ...]
  }
```

In this example, there are attributes for graduateYear, zipCode, and customSegment. For the attribute zipCode, the corresponding value is 94043, meaning that for a user represented in this example, they reside, work, or otherwise have a connection to the 94043 zip code. Some attributes may have more than one value associated with the attribute. For the attribute customSegment, a timestamp of when the value information is stored by the data store is included along with the value for the attribute (i.e., “10451”).

### Request Processing

Some specific flows for implementing a technique of an embodiment are presented below, but it should be understood that embodiments are not limited to the specific flows and steps presented. A flow of another embodiment may have additional steps (not necessarily described in this application), different steps which replace some of the steps presented, fewer steps or a subset of the steps presented, or steps in a different order than presented, or any combination of these. Further, the steps in other embodiments may not be exactly the same as the steps presented and may be modified or altered as appropriate for a particular application or based on the data.

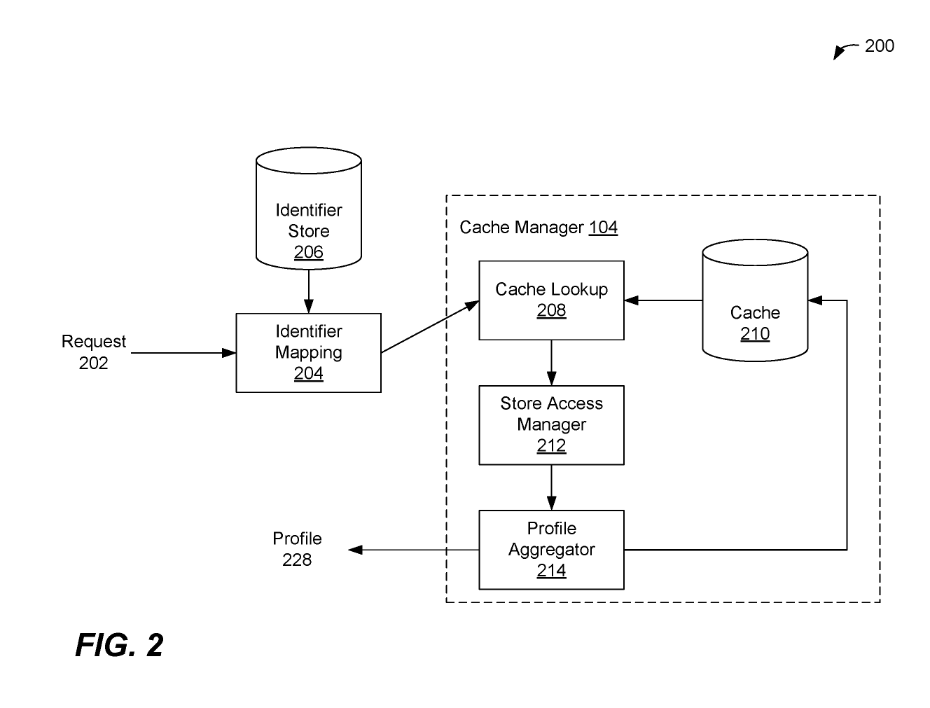

FIG. 2 shows an example flow 200 of how a request is processed by various components of the content selection system 100, in an embodiment. In a first step, a request 202 is received by the content selection system 100. The request may include various pieces of information, such as identifying information of an entity that made the request, where the entity made the request, and other information. In a second step, an identifier mapping component 204 determines from an identifier store 206 what identifying information is included with the request, a dominant identifier associated with the identifying information, and other identifiers associated with the dominant identifier. The cache manager component 104 provides further processing of the request. In a third step, the cache manager component 104 performs a cache lookup 208. For example, the cache manager component 104 will determine from a cache 210 if there exists a stored profile for the dominant identifier, as well as when the stored profile was generated. In a fourth step, a store access manager 212 will determine which profile, if any, is returned in response to the request. For example, the store access manager 212 may determine what data is to be included with a request. The store access manager 212 may optionally determine a context and expected response time to satisfy the request. Various embodiments of the cache manager component 104 may include all or a subset of these options to reply to the request:

Cache Hit.

If the store access manager 212 determines that there exists a stored profile and that the stored profile for the dominant identifier is not stale, then the store access manager 212 may return the stored profile.

Cache Miss—Hard Cache Miss.

If the store access manager 212 determines that there is no stored profile for the dominant identifier, then the store access manager 212 may choose to generate a new profile. For example, the store access manager 212 is aware that first and second data sources would be required to generate the new profile. Based on an expected response time for the first and second data sources (e.g., historical analysis of response times), the store access manager 212 determines that, although the stored profile is unusable, it would be possible to generate the new profile and timely respond to the request. For example, the store access manager 212 determines a timeout for fetching data from a data store. If one or more data stores timeout and cannot produce their profile information before the timeout, then the store access manager 212 will mark any profile created for the dominant identifier as incomplete. The incomplete profile may still be transmitted for use. Additionally, the store access manager 212 may asynchronously fetch information from the timed out data sources to generate a complete profile. This complete profile is stored for use during subsequent requests.

Cache Miss—Soft Cache Miss.

If the store access manager 212 determines that the stored profile for the dominant identifier is stale, then the store access manager 212 may choose to provide the stored profile. The store access manager 212 determines that it would still be valuable to provide the stored profile in response to the request, even when the profile is stale. After responding to the request, the store access manager 212 instructs the new profile to be generated, asynchronous to responding to the request to be used for any subsequent requests.

No response.

If the store access manager 212 determines that the stored profile for the dominant identifier is stale and that it would not be valuable to provide the stored profile, then the store access manager 212 may choose to forgo responding to the request. This may mean that the request will be ignored or that the content selection system 100 will select content without associated profile information. After choosing to forgo responding to the request, the store access manager 212 may instruct a new profile to be generated, asynchronous to responding to the request.

In a fourth step, a profile aggregator 214 provides a profile 228 according to the path determined by the store access manager 212. The profile aggregator 214 may access the data stores component 106, as described in greater detail elsewhere. This profile is stored in the cache 210, for potential future use. In a fifth step, the profile is provided in response to the request.

### Data Conflict Resolution

In an embodiment, two or more data sources may store conflicting information. For example, if three data stores provide an attribute “company” for users, the profile manager system 102 will need to determine whether the information is usable and, if there is a conflict among the three data sources, how to resolve the conflict.

There may be situations where multiple data sources provide the same attribute, but a different value for the attribute:

Vertical Sharding of Data:

If there are too many values associated with a single attribute name, then those values may be values that exist because they were sharded across multiple sources. The profile manager system 102 would need to merge them together when returning the results. An example of such attribute is advertisement segment. A user may belong to many advertisement segments (e.g., frequent travelers, business decision makers). These advertisement segments are created and managed by each respective data source. However, since they may all be applicable, these advertisement segments need to be merged under a single attribute (because they are all used together).

Backfilling targeting data: This occurs when a reliable data source may use another, less reliable data source, to backfill missing information it needed. In this case, the reliable data source has priority over the potentially less reliable source.

Near real-time overwrite: Some of targeting attributes have near real-time requirements. This means a user action should propagate through the system in a matter of seconds and take effect. Examples of such attributes include retargeting ad segments and user opt-outs. This may result in conflicts, when only a subset of the data sources is updated.

The profile manager system 102 may employ one or more methods to resolve a conflict:

Unioning: where data from two data sources are combined together. This is the default conflict resolution rule if none is specified. Thus, if two different employers of a user are indicated in different data sources, then information about both employers may be later used to identify relevant content items for the user.

Priority based overwrite: If one data source has higher priority (e.g., the higher reliable source from sharding) when a conflict occurs, then the profile manager system 102 overwrites values from the lower priority data source. For example, in the backfilling example provided above, the profile manager system 102 will determine that a reliable data source needed to backfill information, so when comparing the reliability of the piece of backfilled information with information from elsewhere, a comparison is made whether the backfilled data source is more or less reliable than information available elsewhere.

Freshness based merge: The profile manager system 102 reviews timestamps associated with values to determine which value is newer. The newer value is selected. Freshness based merge may be used when a data store uses delta updates (such as data updates stored in a separate data store) that are merged with a daily snapshot (stored in another data store) based on timestamp differences of the data. For example, a delta store may include fresher information that the daily snapshot data store when there was a change made to data after the daily snapshot was created.

### Data Source Onboarding

In an embodiment, the profile manager system 102 allows easy onboarding and off-boarding of data sources. For example, there may be many different data sources, or different versions of data sources that may be used to generate a profile. In order to test how effective the data sources are (e.g., when being used to generate a profile to select content items), data sources may be onboarded or off-boarded as needed. To onboard a new data source, if the new data source already stores data in the data schema, then an adaptor instance and configuration file is sufficient for the profile manager system 102 to access and make sense of the data stored within the data source. When processing queries using information stored in the data source, the new data source is accessible over a network for use by the profile manager system 102.

### Removing Information from Profiles

In an embodiment, the content selection system 100 includes features to remove information from existing profiles. Removal of information is generally specific to the data source. Some examples of data sources include:

Expiring Data Source.

A data store may be collecting a type of information that expires. As an example, a Web browsing data store incudes Web browsing history of a user. Web browsing information from the data store may only be kept and used for a certain period of time. Thus, if profiles include information from the Web browsing data store, then, when the certain period of time has passed, the profile must be updated to remove information in the profile generated based on the Web browsing data store. An example is information collected by a web browser. User information collected by the web browser is tied to a web browser identifier. In many areas of the world, information collected and indexed by a browser identifier is usable only for a certain length of time, as defined by laws in each country, state, or locality.

Opt-Out.

A data store may be collecting a type of information that a user provides about themselves (e.g., through their browsing history, entry of information online, language selection, or other). However, after the user has provided the information, the user may choose to un-share or opt-out from allowing the content selection system 100 to use the information. For example, if a user has shared their location information and it is stored in a location data source, they may later decide to no longer share their location information. Thus, if the user's profile includes their location information, then the system removes this location information. In another example, a user may select a language for content they would like to receive. However, subsequent to their selection, they decide they would no longer like to receive content in their selected language. Thus, if the user's profile includes language information, then the content selection system 100 removes this language information.

The content selection system 100 may include a listener, which monitors specific data stores. The monitored data stores may be those indicated as including information that may be subject to a request for removal. When a removal request is received, the content selection system 100 receives an event that contains the user identifier, and generates an updated profile for the user to replace the previously stored profile.

### Example Embodiment of Using Adaptors to Generate Profiles

In an embodiment, the profile manager system 102 includes multiple data stores. These data stores include information stored in a specific schema. However, in order to access information in each store, an adaptor and a data store specific configuration file are used to properly retrieve and process requests or queries made against the data store. For example, the content selection system 100 includes a first data source and a second data source with a first configuration file for the first data source and a second configuration file for the second data source. These configuration files are used by adaptor instances, such as a first adaptor and a second adaptor, to access information, respectively, in the first and second data stores. A consolidator engine is included to incorporate the information retrieved by the profile manager system 102 from the data stores.

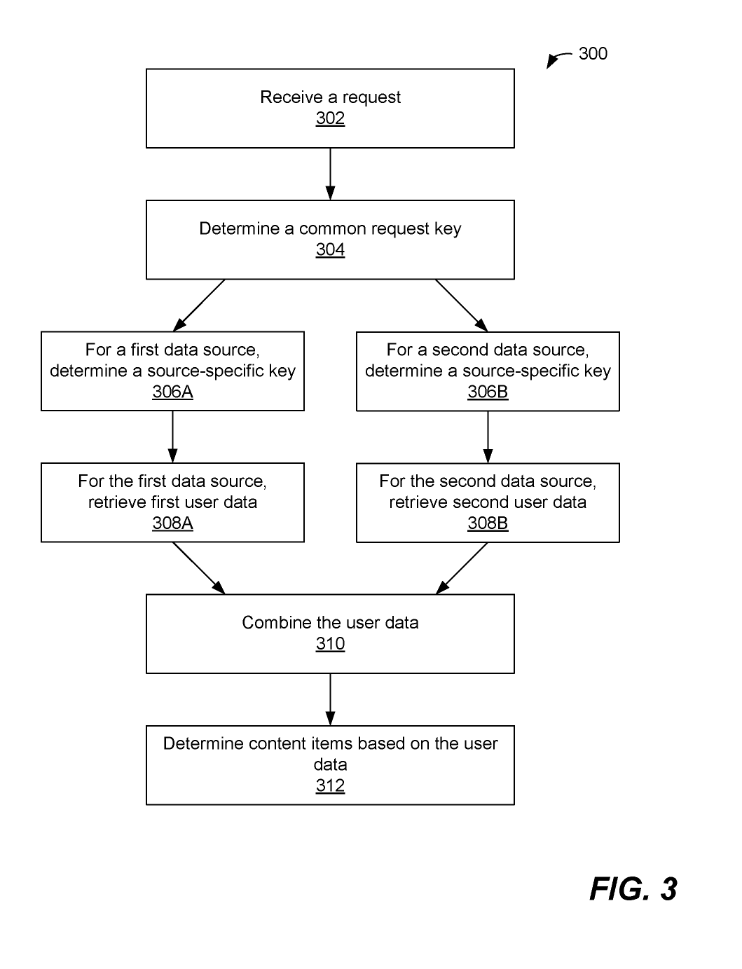

FIG. 3 is a flowchart that depicts an example process 300 for using adaptors to generate profiles. In a step 302, the content selection system 100 receives requests for profiles of users associated with the requests. The profiles may be used to help match what content item would best suit their interests. In a step 304, the content selection system 100 includes a method of determining, from the request, what user identifier is associated with the request. This user identifier may be included with a common request key (or common key), in that adaptors are able to convert the common request key into various formats compatible with each respective data store. In an embodiment, the common request key includes: the dominant identifier for a user associated with a request, what attributes of information are needed to satisfy the request, what data sources to request information from, what versions (if any) of information are needed, or any combination of these.

In an embodiment, the dominant identifier may be used to look up all identifiers associated with the dominant identifier. Cache data is looked up according to the dominant identifier. If there is a cache miss, all identifiers may be used to look up all the data known about the user. A caller context may be included with a common request key (or a source-specific key as described later) that determines what subset of attributes values should be returned in response to the common request key. The caller context may also specify various adjustments need to be done to the returned attribute values (e.g., data formatting, data language types, or other adjustments).

The common request key may be supplied by the request itself or through processing by the content selection system 100. For example, the content selection system 100 determines that a request contains an identifier. This identifier does not necessarily correspond with a common request key. In this case, the content selection system 100 will determine from available information, what the common request key should be, based on the identifier used in the request.

In response to receiving the request, the content selection system 100 will gather user information stored in the first and second data sources. In a step 306A, based on the common request key, the adaptor converts the common request key into a source-specific key in the first source-specific key format. This may be because the common request key, although it contains all information necessary to retrieve user information based on the request, is formatted in a way that is not usable to query the data source. In a step 308A, the adaptor uses the first source-specific key to retrieve first user data. Similarly, in steps 306B and 308B, the profile manager system 102 determines a second source-specific key from the second data source to retrieve second user data.

In a step 310, the consolidator engine combines the first user data and the second user data to generate combined data. As discussed in greater detail elsewhere, the content selection system 100 may perform conflict resolution and other remediation to reconcile different or conflicting information stored at the different data sources. In a step 312, the content selection system 100 determines, based on the combined data, one or more content items to send to a client device that is associated with the user identifier.

### Example Embodiment of Using Adaptors to Perform Profile Effectiveness Testing

In an embodiment, the content selection system 100 may be used to performing profile effectiveness experiments. For example, the content selection system 100 may determine that profiles generated with data from a first data source is more accurate than profiles generated with data from a second data source.

The content selection system 100 offers a testing method of testing the effectiveness of different data stores. This is facilitated by using a method to easily index which data stores are to be used to satisfy a particular request. For example, the content selection system 100 includes a method to define slices of traffic, and for each slice, it can specify different experiments (e.g., using AB testing configuration). For instance, for five percent of users, the content selection system 100 uses store1:v1, store2:disabled, store3:v3 while for ninety-five percent of users the content selection system 100 uses store1:v2, store2:v1, store3:v3. Depending on results of the experiment, the more successful slice may be chosen.

In an embodiment, the content selection system 100 uses a concatenated string specifying which data stores are to be used for a particular request. This allows the testing of different data stores, to determine which data stores are the most predictive in positive outcomes for the content selection system 100. For example, the string “v1_disabled_v3_disabled_v1_v2” specifies whether a particular data store is to be included when satisfying a request. Each data store is indexed in the string consecutively, with an underscore character (“_”) separating each data store. In the example string, data stores 1, 3, 5, and 6 are to be used in satisfying a request, while data stores 2 and 4 are not to be used. Additionally, the string specifies which version of information to be used. As an example, the string specifies that version 1 of data source 1 is to be used. In an embodiment, an experiment may involve different versions of a data source. For example, instead of comparing two data sources, the content selection system 100 may test versions 1 and 2 of a data source.

Although a specific example of a string to reference data stores is used here, many other types of formatted strings may be used. For example, instead of using underscores, other characters (e.g., %, !), more than one character, or no characters at all may be used. However, any other method may be used, such as a binary indication (e.g., zeroes and ones) of whether a data store is to be used when satisfying a request.

In an embodiment, the content selection system 100 allows users to test data sources by specifying how much traffic is to be used for a given treatment. For example, for a given number of requests (or traffic), the content selection system 100 may select a certain percent of the requests to use a specific treatment. A treatment is a specific test scenario and a test may include multiple scenarios. For example, Table 3 below shows an example test.

TABLE 3

| Traffic Percent | Treatment (source1_source2) |
|---|---|
| 10% | v2_disabled |
| 90% | disabled_v1 |

In the example test, a first treatment will be selected for ten-percent of the requests. For these requests, version 1 of data source 1 will be used but data source 2 will be disabled (e.g., data stored in data source 2 will not be used). Selecting which requests will be handled using which treatment may be done at random or using other assignment techniques.

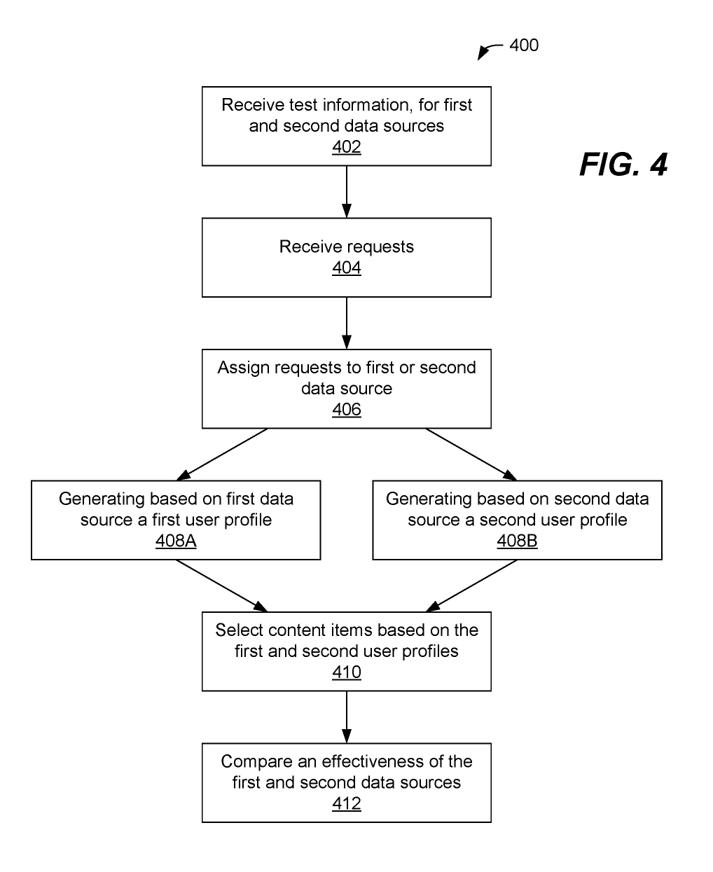

FIG. 4 is a flowchart that depicts an example process 400 for using adaptors to perform profile effectiveness testing. In a step 402, the content selection system 100 receives test information, to test first and second data sources. For example, the first and second data sources may be derived data sources. The first and second data sources may be of any type of data source as described, including third-party data sources. Further, derived data sources may include derived information from third-party sources, internal sources, or any of the other sources as described. These data sources may share the same source data (e.g., they are generated based on the same set of information sources), but generated using different methods. As an example, different modeling techniques may be used to generate derived data. Some examples of modeling techniques include linear modeling, time series modeling, stochastic modeling, nested modeling, and many other types of modeling. Even when provided with the same input, different modeling techniques may result in different derived data. Further, when using the same modeling technique, results may be different when constants used in the modeling technique are different. Constants are used in modeling techniques to determine the relative importance of different variables (or inputs) to the model as compared to other variables. Even when the same data and the same modeling technique is used, modifying constants will result in certain variables having greater or less effect in the resultant derived data.

In a step 404, the content selection system 100 receives requests for profiles. These requests may be content requests made to any of one or more Websites, applications, or other. The content selection system 100 is tested in a “live” environment, where real users are making the requests for content items. The users who make the requests may be registered or non-registered users with respect to the content provider to which the requests are directed. Some content providers allow registered and non-registered users to submit content requests.

In an embodiment, the content selection system 100 receives requests for profiles after receiving the test information. This allows the content selection system 100 flexibility in being able to run tests “on-the-fly” when a researcher would like to know how changes in the content selection system 100 would affect the content selection system 100.

In a step 406, the content selection system 100 assigns requests to the first or second data source. This means that, for at least a request and another request, the first request is satisfied using information from the first data source and the second request is satisfied using information from the second data source. The request and the other request may be from different users with different user identifiers.

In a step 408A, the content selection system 100 generates, based on the first data source, a first user profile. Similarly, in a step 408B, the content selection system 100 generates, based on the second data source, a second user profile.

In an embodiment, the profiles generated from the first and second data sources share at least one data source in common. This means that profiles generated from the first and second data sources share a third data source. This assists the content selection system 100 in establishing a control for generated profiles. For example, in order to compare the effectiveness of the first and second data sources, other data sources used should remain constant so that noise in the resultant test data is reduced.

In a step 410, the content selection system 100 selects content items based on the first and second user profiles. The selected content items for the first and second user profiles may share all, at least some, or no content items.

In a step 412, the content selection system 100 determines, based on the combined data and the combined test data, whether the first data source is more effective than the second data source. Various methods may be used to achieve this, such as by using AB testing, as discussed in greater detail elsewhere.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

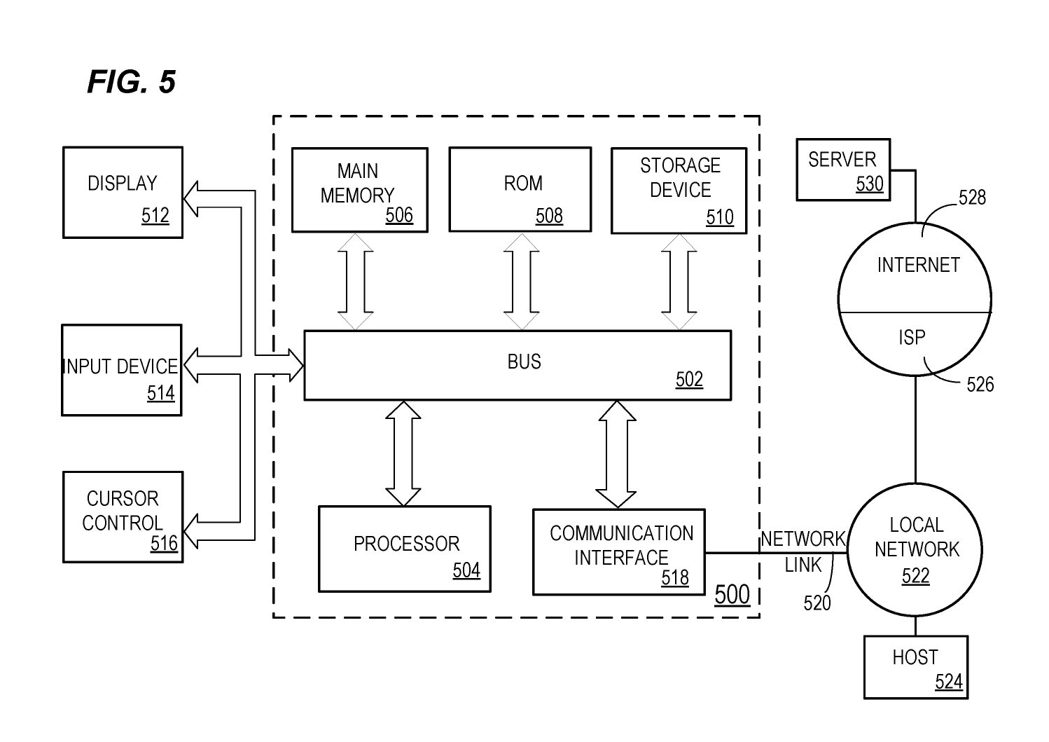

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 650 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A system comprising:
a plurality of data sources that includes a first data source and a second data source;
a first configuration file for the first data source;
a second configuration file for the second data source;
a plurality of adaptor instances that includes a first adaptor and a second adaptor;
a consolidator engine;
one or more processors;
one or more storage media storing instructions which, when executed by the one or more processors, cause:
receiving a request that is associated with a user identifier;
in response to receiving the request:
the first adaptor generating, based on a common request key and the first configuration file, a first source-specific key that is associated with the user identifier;
the first adaptor retrieving, based on the first source-specific key, from the first data source, first user data;
the second adaptor generating, based on the common request key and the second configuration file, a second source-specific key that is associated with the user identifier;
the second adaptor retrieving, based on the second source-specific key, from the second data source, second user data;
the consolidator engine that combines the first user data and the second user data to generate combined data;
determining, based on the combined data, one or more content items to send to a client device that is associated with the user identifier.

2. The system of claim 1, further comprising:
a third data source included with the plurality of data sources;
a third configuration file for the third data source;
a third adaptor included with the plurality of adaptor instances;
wherein the one or more storage media storing instructions which, when executed by the one or more processors, further cause:
receiving an indication that the second data source and the third data source are subject to a test;
receiving a second request that is associated with a second user identifier that is different than the user identifier;
in response to receiving the second request:
the first adaptor generating, based on another common request key and the first configuration file, a third source-specific key that is associated with the second user identifier;
the first adaptor retrieving, based on the third source-specific key, from the first data source, third user data;
the third adaptor generating, based on the other common request key and the third configuration file, a fourth source-specific key that is associated with the second user identifier;
the third adaptor retrieving, based on the fourth source-specific key, from the third data source, fourth user data;
the consolidator engine that combines the third user data and the fourth user data to generate combined test data;
determining, based on content items selected using the combined data and the combined test data, whether the third data source is more effective than the second data source.

3. The system of claim 2, wherein the one or more storage media storing instructions which, when executed by the one or more processors, further cause:
selecting the request to be used for the test in order to determine the effectiveness of combined data generated using the second data source;
selecting the second request to be used for the test in order to determine the effectiveness of combined data generated using the third data source.

4. The system of claim 2, wherein the user identifier and the second user identifier represent different users of the system.

5. The system of claim 2, wherein the one or more storage media storing instructions which, when executed by the one or more processors, further cause:
determining, based on the combined test data, one or more second content items to send to a second client device that is associated with the second user identifier;
wherein the one or more content items sent to the client device includes a first content item that is not sent to the second client device.

6. The system of claim 2, wherein the second data source and the third data source comprise derived data sources, and the second data source and the third data source are derived from the same one or more shared data sources.

7. The system of claim 6, wherein the second data source is derived using a first statistical modeling technique and the third data source is derived using a second statistical modeling technique that is different than the first statistical modeling technique.

8. The system of claim 6, wherein the second data source and the third data source are derived using a particular statistical modeling technique, wherein a first statistical model used to generate first derived data for the second data source comprises a first set of constants and a second statistical model used to generate second derived data for the third data source comprises a second set of constants that is different than the first set of constants.

9. The system of claim 1, further comprising:
determining, based in part on the user identifier received with the request, the common request key for the request.

10. The system of claim 1, further comprising:
a third data source included with the plurality of data sources;
a third configuration file for the third data source;
a third adaptor included with the plurality of adaptor instances;
wherein the one or more storage media storing instructions which, when executed by the one or more processors, further cause:
receiving an onboarding request for the third data source, wherein the onboarding request specifies that the third data source may be used when responding to subsequent requests made after the request.

11. The system of claim 1, wherein the common request key specifies a subset of information stored in the first data source relating to the user identifier to be retrieved from the first data source.

12. The system of claim 1, wherein the plurality of adaptor instances comprise separately executing instances of the same digital instructions.

13. The system of claim 1, wherein the one or more storage media storing instructions which, when executed by the one or more processors, further cause:
in response to receiving the request, the consolidator engine providing performance benchmarks on the first adaptor retrieving the first user data.

14. A method comprising:
receiving a request that is associated with a user identifier;
in response to receiving the request:
generating, by a first adaptor, based on a common request key and a first configuration file, a first source-specific key that is associated with the user identifier;
retrieving, by the first adaptor, based on the first source-specific key, from a first data source, first user data;
generating, by a second adaptor, based on the common request key and a second configuration file, a second source-specific key that is associated with the user identifier;
retrieving, by the second adaptor, based on the second source-specific key, from a second data source, second user data;
combining the first user data and the second user data to generate combined data;
determining, based on the combined data, one or more content items to send to a client device that is associated with the user identifier.

15. The method of claim 14, further comprising:
receiving an indication that the second data source and a third data source are subject to a test;
receiving another request that is associated with a different user identifier than the user identifier;
in response to receiving the other request:
generating, by the first adaptor, based on another common request key and the first configuration file, a third source-specific key that is associated with the different user identifier;
retrieving, by the first adaptor, based on the third source-specific key, from the first data source, third user data;
generating, by a third adaptor, based on the other common request key and a third configuration file, a fourth source-specific key that is associated with the different user identifier;
retrieving, by the third adaptor, based on the fourth source-specific key, from the third data source, fourth user data;
combining the third user data and the fourth user data to generate combined test data;
determining, based on the combined data and the combined test data, whether the third data source is more effective than the second data source.

16. The method of claim 15, further comprising:
determining, based on the combined test data, one or more content items to send to another client device that is associated with the different user identifier;
wherein the at least one content item to send to the client device includes a first content item that is not sent to the other client device.

17. The method of claim 15, further comprising:
selecting the request to be used for the test in order to determine the effectiveness of combined data generated using the second data source;
selecting the other request to be used for the test in order to determine the effectiveness of combined data generated using the third data source.

18. The method of claim 15, wherein the request is for one or more content items to be displayed on a first Web page and the other request is for one or more content items to be displayed on a second Web page.

19. One or more storage media storing instructions which, when executed by one or more processors, cause:
receiving a request that is associated with a user identifier;
in response to receiving the request:
generating, by a first adaptor, based on a common request key and a first configuration file, a first source-specific key that is associated with the user identifier;
retrieving, by the first adaptor, based on the first source-specific key, from a first data source, first user data;
generating, by a second adaptor, based on the common request key and a second configuration file, a second source-specific key that is associated with the user identifier;
retrieving, by the second adaptor, based on the second source-specific key, from a second data source, second user data;
combining the first user data and the second user data to generate combined data;
determining, based on the combined data, one or more content items to send to a client device that is associated with the user identifier.

20. The one or more storage media storing instructions of claim 19, further comprising:
receiving an indication that the second data source and a third data source are subject to a test;
receiving another request that is associated with a different user identifier than the user identifier;
in response to receiving the other request:
generating, by the first adaptor, based on another common request key and the first configuration file, a third source-specific key that is associated with the different user identifier;
retrieving, by the first adaptor, based on the third source-specific key, from the first data source, third user data;
generating, by a third adaptor, based on the other common request key and a third configuration file, a fourth source-specific key that is associated with the different user identifier;
retrieving, by the third adaptor, based on the fourth source-specific key, from the third data source, fourth user data;
combining the third user data and the fourth user data to generate combined test data;
determining, based on the combined data and the combined test data, whether the third data source is more effective than the second data source.
